(19) United States
(12) Patent Application Publication
(10) Pub. No.: US 2026/0122756 A1
(43) Pub. Date: Apr. 30, 2026

(54) Scalable, Modular Warp Reactor for Generating Ultra-Intense High Energy Density Charged Particle Rings for Fusion Energy Production, Combined Radiation Environments, Advanced Propulsion and Space-time Metric Engineering

(71) Applicant: National Nuclear Security Administration U.S. Department of Energy, Washington, DC (US)

(72) Inventor: Michael Gordon Anderson, Discovery Bay, CA (US)

(21) Appl. No.: 19/082,557

(22) Filed: Mar. 18, 2025

Related U.S. Application Data
(60) Provisional application No. 63/565,471, filed on Mar. 14, 2024.

(51) Int. Cl. H05H 7/06

(52) U.S. Cl. CPC H05H 7/06

(57) ABSTRACT

A compact, modular, and scalable pulsed power-driven radiation source system utilizes Dense Plasma Focus assemblies and Ion Ring Marx Generators in a novel configuration to generate ultra-intense charged particle beams. The system's WARP core integrates coaxially aligned, face-to-face Dense Plasma Focus assemblies with reflex triodes and magnetic flux compression to achieve significantly enhanced energy outputs. The invention enables efficient energy production, advanced propulsion capabilities, and new avenues for high-energy physics research while maintaining a reduced physical footprint compared to traditional accelerators. The system achieves GeV-level particle energies through controlled plasma and charged particle ring compression and acceleration, offering applications in nuclear fusion, advanced space propulsion, and radiographic analysis.

This application claims the benefit of U.S. Provisional Application No. 63/656,471, filed Jun. 5, 2024, which is incorporated by reference herein in its entirety

The United States Government has rights in this invention pursuant to Contract No. DE-AC52-07NA27344 between the United States Department of Energy and Lawrence Livermore National Security, LLC for the operation of Lawrence Livermore National Laboratory.

### BACKGROUND OF THE INVENTION

### Field of the Invention

The present invention pertains to the fields of high-energy particle physics, nuclear fusion, advanced propulsion technologies, and radiation production. Specifically, it relates to a device capable of generating, compressing and accelerating charged particle rings to achieve ultra-intense relativistic high energy density outputs suitable for various applications.

### Description of the Background

The field of high-energy particle physics has long sought to achieve greater efficiency, compactness, and cost-effectiveness in the generation of charged particle beams and radiation yields. Traditional z-pinch class accelerators, while effective, are often large, expensive, and resource-intensive, limiting their widespread application in both research and practical domains such as energy production and advanced propulsion systems. As the demand for sustainable energy solutions and advanced propulsion technologies grows, there is a critical need for innovations that can provide higher energy outputs at reduced costs and within smaller physical footprints.

In response to this need, the present invention introduces a Wave Accelerated Ring Pinch (WARP) Reactor, a novel and scalable technology designed to produce ultra-intense charged particle beams and high radiation yields. This invention is poised to address key challenges in energy production, space propulsion, and high-energy physics research, providing a versatile platform for exploring new physical regimes and practical applications.

### SUMMARY OF THE INVENTION

The present invention relates to a WARP reactor, a scalable and modular device that utilizes state-of-the-art pulsed power modules to generate, compress, and accelerate charged particle beams, resulting in significantly enhanced energy outputs. The WARP reactor's core components include Dense Plasma Focus (DPF) assemblies with embedded reflex triodes that interact under controlled magnetic fields to produce ultra-intense charged particle beams. These charged particle beams are radially compressed and azimuthally accelerated within the WARP reactor core, leading to outputs that far exceed those of conventional z-pinch accelerators.

The WARP reactor is designed to be compact and cost-effective, with applications spanning nuclear fusion energy production, advanced space propulsion, and high-energy density physics research. Its innovative configuration allows for greater efficiency in energy production and radiation generation, making it suitable for both scientific and practical applications.

An exemplary embodiment of the present invention comprises a compact, modular, and scalable pulsed power-driven radiation source system. The system comprises the following: at least two DPF Marx modules, at least two Ion Ring Marx Generators (IRMG), and a WARP core.

The WARP core further comprises at least two DPF assemblies. The DPF assemblies are configured to receive pulsed power from the at least two DPF Marx modules. Within embodiments of the present invention pairs of DPF assemblies are coaxially aligned and physically arranged so that a first DPF assembly and a second DPF assembly are oriented to face each other, thus enabling each facing DPF assembly to have the capability to generate and accelerate plasmoids towards the opposing DPF assembly along the same axis, with subsequent merging of the plasmoids and plasmoid liner compression.

Each DPF assembly further comprises a reflex triode assembly for the generation and acceleration of charged particle beams/rings. The reflex triode assemblies comprise a collection of components that include IRMG anodes, IRMG cathodes, reflex triode B-insulation pulse magnets, and IRMG gas puff valves. Each reflex triode assembly is configured to receive pulsed power from a corresponding operably connected IRMG.

A magnetic flux compression system is integrated with the WARP core to provide radial compression and azimuthal acceleration of merged charged particle rings to increase the energy of the merged charged particle rings. As a result, the at least two DPF Marx modules, the at least two IRMGs, and the WARP core are operatively coupled to achieve a compact, scalable, modular system for generating relativistic high-energy density charged particle beams and facilitating nuclear fusion, advanced propulsion, and radiographic applications.

Another exemplary embodiment of the present invention comprises a method for generating high-energy density charged particle beams. The method comprises the steps of providing a compact modular and scalable pulsed power-driven radiation source system. The system comprises at least two DPF Marx modules, at least two IRMGs, and a WARP core. The WARP core comprises at least two DPF assemblies and is integrated with a magnetic flux compression system, each DPF assembly further comprising a reflex triode assembly.

The method further comprises the steps of configuring pairs of DPF assemblies within the WARP core to be coaxially aligned and oriented to face each other, delivering pulsed power from the DPF Marx modules to the DPF assemblies and delivering pulsed power from a respective IRMG to a corresponding reflex triode assembly. Plasmoids and charged particle rings are discharged from each DPF/reflex triode assembly towards the opposing DPF/reflex triode assembly along a common axis.

The steps of merging the plasmoids and charged particle rings at a common focal point within the WARP core are performed by compressing the merged plasmoids and charged particle rings into a plasma liner using the magnetic flux compression system that is integrated with the WARP core. This aspect serves to increase the energy of the plasmoids and charged particle rings, with the result being the generation of relativistic high-energy density charged particle rings for research applications such as nuclear fusion, advanced propulsion, and radiographic assessments.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a side view perspective of an exemplary WARP reactor 100 radiation source of the present invention.

FIG. 2 is an axial end view of the WARP reactor 100 of FIG. 1.

FIG. 3 is a cross-sectional view of the WARP reactor 100 of FIG. 1.

FIGS. 4-11 show a detailed cross-sectional view of an exemplary embodiment of the WARP core 120 and the coaxial face-to-face arrangement of the two DPF assemblies 130a and 130b with a respective reflex triode assembly embedded within each of the DPF assemblies 130a and 130b. Additionally, FIGS. 4-11 show various phases of the WARP reactor 100 in operation.

FIG. 4 shows the DPF assemblies 130a, 130b during the plasmoid 160 lift-off phase.

FIG. 5 shows the DPF assemblies 130a, 130b during the plasmoid 160 run-down phase.

FIG. 6 shows the DPF assemblies 130a, 130b during the plasmoid 160 end of run-down phase.

FIG. 7 shows the DPF assemblies 130a, 130b during the start of the plasmoid 160 run-in phase along with the generation of annular ion beams 175 by the reflex triode assemblies.

FIG. 8 shows the DPF assemblies 130a, 130b plasmoid 160 run-in phase and the generation of annular ion rings 175.

FIG. 9 shows the DPF assemblies 130a, 130b imploding plasmoid 160 liner phase with the ion rings 175 merging phase.

FIG. 10 shows the DPF assemblies 130a, 130b plasmoid 160 pinch phase and the ion ring 175 compression phase.

FIG. 11 shows the DPF assemblies 130a, 130b end fusion-ignition phase 180 enabling the study of relativistic high energy density physics, magneto-inertial fusion, and super-radiant flash x-ray/neutron generation.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views. Herein, the use of the terms first, second, etc., do not denote any order or importance, but rather the terms first, second, etc., are used to distinguish one element from another. Furthermore, the use of the terms a, an, etc., do not denote a limitation of quantity, but rather denote the presence of at least one of a referenced item.

The present disclosure pertains to a pulsed power-driven radiation source system and method that generates radiation through the innovative application of a Wave Accelerated Ring Pinch (WARP) Reactor. This WARP reactor system integrates advanced plasma physics principles to achieve high-efficiency radiation production and ion beam acceleration. At its core, the WARP reactor is designed to leverage cutting-edge components and configurations to create a scalable, modular, and versatile solution for various high-energy applications.

The WARP reactor of the present invention is a novel device that utilizes Dense Plasma Focus (DPF) assemblies and Ion Ring Marx Generators (IRMGs) to produce ultra-intense charged particle beams. The beams are generated, compressed, and accelerated within the core of the WARP reactor, thereby achieving significantly higher energy outputs than traditional methods. Further, the modular design of the WARP reactor allows it to be scaled and adapted for various applications, including energy production, space propulsion, and high-energy physics research.

The central operational region of the WARP reactor is the WARP core, where the primary radiation generation occurs. The WARP core operates in conjunction with pulsed power modules that drive the charged particle beam dynamics of the system and enable the system's efficient functionality. Within exemplary embodiments of the present invention the WARP reactor is distinguished by its integration of DPF assemblies that are arranged in a unique coaxial, face-to-face configuration, each DPF assembly being paired with a reflex triode assembly to optimize the performance of generated charged particle beams. Together, these elements form a compact, cost-effective, and highly adaptable radiation source.

As mentioned above, the central component of the WARP reactor is the WARP core where charged particle beams are generated, compressed, and accelerated. The WARP core comprises dual DPF/reflex triode assemblies with IRMGs positioned at opposing ends of the DPF/reflex triode assemblies. The opposite facing DPF/reflex triode assemblies fire plasma/ion beams towards each other through magnetic cusps into an axial seed magnetic field. The resulting plasma liner and charged particle rings produced by the operation are radially compressed and azimuthally accelerated, leading to high-energy outputs. This innovative design enables the simultaneous generation of charged particle beams, which are directed toward each other for precise interactions.

Embedded within each DPF assembly is a reflex triode assembly that plays a pivotal role in optimizing charge particle beam formation for either positive or negative ions/electrons. The components of the reflex triodes comprise physical IRMG anodes and cathodes along with virtual cathodes or virtual anodes depending on the preferred mode of operations (i.e. IRMG discharge polarities). The reflex triode assemblies further comprise IRMG gas puff valves and B-insulation pulse magnets. This face-to-face coaxial DPF/reflex triode assembly setup is meticulously engineered to enhance symmetry and control during the plasmoids and ion beam generation, merging, and acceleration processes.

Within the exemplary embodiments of the present invention the WARP core is powered by two categories of advanced pulsed-power modules that work in tandem to optimize the performance of the WARP core. The first category comprises the IRMGs, wherein within embodiments of the present invention two impedance-matched units are respectively operably connected to a reflex triode assembly. These IRMGs precisely regulate the timing and provide the necessary energy pulses to drive the ion beams produced by the reflex triode assemblies. The IRMGs are designed to deliver high-voltage pulses in rapid succession, enabling for the efficient transfer of energy and ion beam acceleration. The axial B-insulation, B-seed and B-cusp magnetic fields of the WARP core work to insulate, guide and then subsequently convert the axially directed counter-streaming ion beams into co-rotating merged, azimuthally accelerated and compressed ion rings.

The second category of pulsed-power module comprises the DPF Marx modules. DPF Marx modules can deliver high-current, high-voltage pulses with precise timing to ensure optimal plasmoid beam generation. Within exemplary embodiments of the present invention DPF Marx modules are used to power the DPF assemblies, providing the necessary electrical energy to initiate and sustain the plasma focus by the DPF assemblies and to ensure their operation remains synchronized with the IRMGs. This integrated architecture allows for precise control of ion beam dynamics and plasma interactions, greatly enhancing the overall efficiency and reliability of the system.

The WARP reactor operates through a series of precisely coordinated Phases to achieve high-energy ion ring compression and acceleration. Phase 1 begins with the creation of the B-insulation, B-seed and B-cusp magnetic fields to ensure full B-field diffusion through the metal structures along with gas injection via the DPF and IRMG annular puff valves and subsequent firing of the DPF Marx modules to initiate dual DPF plasmoid generation, lift-off and run-down.

Phase 2 occurs as the two DPFs begin their run-in sequence and the IRMGs are fired to produce the dual tubular ion beams. Phase 3 is when the DPFs return currents have merged and the dual axially directed ion beams have passed through their respective B-cusp fields to become co-rotating and merged ion rings in the embedded B-seed field.

Phase 4 is the DPF plasma liner implosion sequence which provide the necessary flux compression and subsequent ion ring pinch and azimuthal acceleration of Phase 5. Within Phase 5 the carefully timed plasma liner implosion compresses the merged ion rings radially while simultaneously accelerating them azimuthally, amplifying their energy by up to 10³ times their initial levels and achieving GeV energy scales. This compression and acceleration generate high-energy radiation, which can be utilized for diverse applications such as nuclear fusion, advanced propulsion systems, high-resolution imaging technologies, and researching advanced high-energy physics research into the interplay between general relativity and quantum field theory, and potential Warp, Unruh, Dynamic Casimir effects and ultra-high frequency gravitational wave generation.

### Scientific Mechanisms Driving the WARP Reactor

The WARP reactor's operation is rooted in advanced plasma physics principles, particularly the conservation of magnetic flux and canonical angular momentum.

Ion Beam Compression and Acceleration-Within exemplary embodiments of the present invention tubular ion beams (at MeV levels) are injected into the WARP core from opposite facing reflex triode assemblies. Magnetic B-insulation, B-seed and B-cusp fields guide the ion beams, forming them into co-rotating ion rings near the mid-plane of the WARP core. The ion rings are then radially compressed (or “pinched”) and azimuthally accelerated through the DPF plasma liner implosion and flux compression process, achieving ion ring azimuthally directed energies up to 10³ times the initial axially directed ion beam energy (at GeV levels).

Flux and Charged Particle Ring Compression Dynamics—The physics behind charged particle ring radial compression in the WARP Core is as follows: Magnetic flux (Φ_{z}) compression (i.e. conservation of seed Φ_{z} during DPF z-pinch driven imploding liners: Φ_{z}=B_{z}πr_{L}²=constant; where (B_{z}) is the axial magnetic field enclosed within imploding liner radius (r_{L})) creates a “Magnetic Wave” (i.e. seed B_{z} amplitude rapidly swells/increases since flux conservation dictates that B_{z}∝r_{L}⁻²) which forces (i.e. F=qV×B) charged particle rings to radially compress (i.e. decrease in Larmor radius: r=γm V_{θ}/qB).

Charged Particle Ring Azimuthal Acceleration Dynamics-Due to the conservation of canonical angular momentum (i.e. p_{θ}=γmrV_{θ}+qΦ_{z}/2π=constant) and adiabatic flux conservation condition (i.e. p_{θ}²/B_{z}=constant or p_{θ}r=constant) the charged particle ring azimuthal velocities scale as: V_{θ}∝(rᵢ/r_{f}) for γ=1.

Energy Transfer Processes—And since Φ_{z} and p_{θ} are both conserved in the device, for non-relativistic regimes the final energy of the ion ring scales by E_{f}=½γNm(V_{θf})²˜Eᵢ(rᵢ/r_{f})², whereas for relativistic charged particle motion in pulsed B-fields, γ varies due to ∇×E=−(δB/δt) and therefore E_{f}˜Eᵢ (B_{f}/Bᵢ), thus enabling the WARP reactor to achieve significant energy outputs in GeV range levels.

Electromagnetic Field Manipulation-Within the exemplary embodiments of the present invention the B-cusp and B-seed magnetic coils guide and stabilize the ion beams, thereby ensuring precise alignment and efficient energy transfer during the ion ring compression and acceleration phases.

The WARP reactor introduces several significant advancements over traditional radiation sources, offering a combination of compact design, enhanced efficiency, cost-effectiveness, and versatility. The coaxial face-to-face arrangement of the DPF assemblies reduces the overall size and complexity of the WARP reactor while incorporating modular components that enable scalability and customization for various applications. Enhanced efficiency is achieved through the integration of reflex triode assemblies and IRMGs, which improve energy transfer and beam stability, along with optimized magnetic field configurations that minimize instabilities during ion ring compression and acceleration.

The compact design also contributes to cost-effectiveness by lowering material and operational expenses, making the reactor economically viable across a range of uses. Further, the WARP reactor demonstrates remarkable versatility, supporting applications such as clean and sustainable nuclear fusion energy, high-efficiency propulsion systems for space exploration, precise flash radiography for studying implosion and explosion dynamics, and advanced high-energy physics research into the interplay between general relativity and quantum field theory, and potential Warp, Unruh, or Dynamic Casimir effects via the modified Einstein Field Equation

$${G}_{μ v} = \frac{8 π G}{{c}^{4}} ( S + A ) {T}_{μ v} .$$

Within the modified Einstein Field equation, the terms “S” and “A” respectively denote the Sarfatti-Anderson plasma metamaterial factor and the Anderson Unruh/Casimir factor which encapsulate three distinct methods for enhancing the coupling of energy-momentum to spacetime curvature, the following methodologies being described as:
1) The Sarfatti-Anderson Effect, which comprises the confinement of multi-layered Relativistic High-Energy Density (RHED) plasma and charged particle rings under Terahertz-to-Petahertz (THz-PHz) radiation fields to facilitate the synthesis of advanced plasma/ring metamaterials, thus enabling novel electromagnetic interaction regimes;
2) The Anderson Effect in the Unruh Regime, which comprises exploiting azimuthal acceleration exceeding the Unruh effect threshold within multi-pass RHED plasma and charged particle ring configurations to induce localized Leidenfrost-type vortices. These vortices represent spacetime phase transition layers exhibiting gravitational memory and complex non-linear dynamics; and,
3) The Anderson Effect in the Casimir Regime, which comprises the inducing of implosion dynamics surpassing the Casimir effect threshold in RHED plasma and charged particle rings to produce internal negative energy densities. This mechanism enhances the stabilization of magnetic fields exceeding 5-kiloTesla (>5 kT) by introducing additional confinement effects, effectively mitigating rapid disassembly of plasma/ring metamaterial structures.

Exemplary embodiments of the present invention will now be described more fully with reference to the accompanying drawings. The drawings described herein are for illustrative purposes only of selected embodiments and not all possible implementations and are not intended to limit the scope of the present disclosure. Corresponding reference numerals indicate corresponding parts throughout the several views of the drawings.

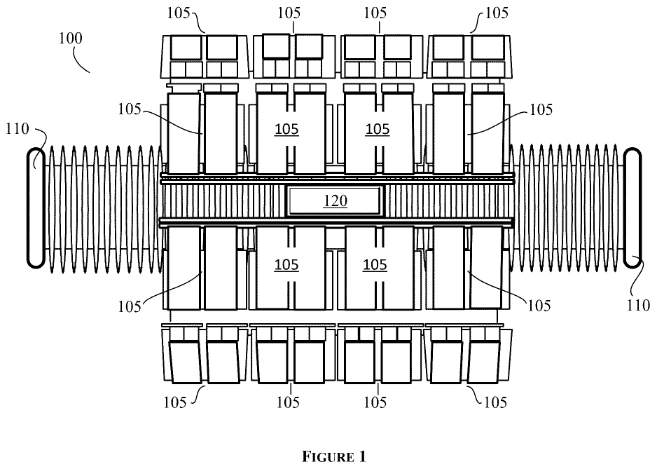

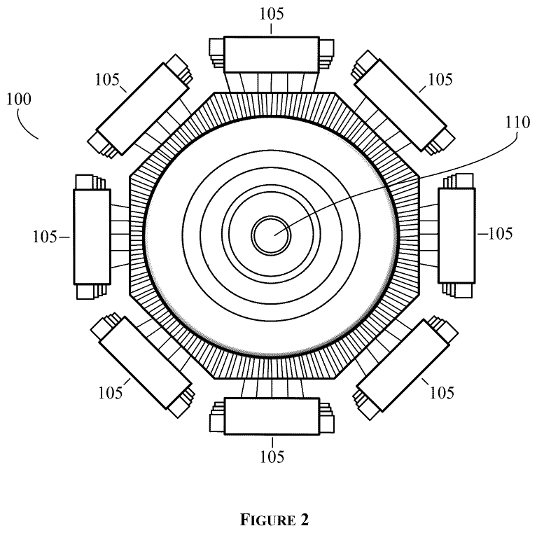

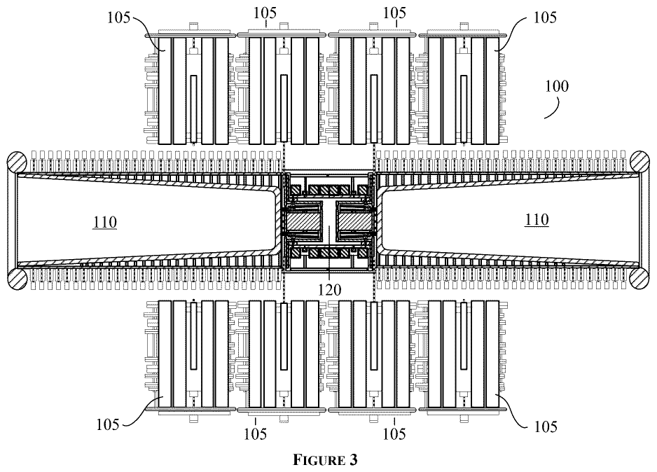

FIG. 1 shows a side view of an exemplary WARP reactor 100 radiation source of the present invention. FIG. 2 shows an axial end view of the WARP reactor 100 of FIG. 1, while FIG. 3 is a cross-sectional view of the WARP reactor 100 of FIG. 1. Within FIGS. 1-3 the WARP reactor 100 is shown comprising a plurality of DPF Marx modules 105 that are encircling two IRMGs 110 positioned at opposite sides of the WARP core 120.

Within FIGS. 3-11 the WARP reactor 100 is shown having a WARP core 120 that includes two DPF assemblies 130a, 130b arranged in a coaxial, face-to-face configuration. The DPF assemblies 130a, 130b are arranged in such a manner that allow an opposing DPF assembly 130a, 130b to fire plasmoids and ion beams directly at the opposite DPF assembly 130a, 130b. Two reflex triode assemblies are respectively embedded inside the dual DPF assemblies 130a and 130b. Each reflex triode assembly comprising an anode 140a, a cathode 140b, a puff valve 140c, a B-insulation pulse coil magnet 140e, and a cavity that helps to resonate generated microwaves.

In operation, the reflex triode assemblies operate by the injection of electrons into the gas-puff-filled physical diode-like structure of the reflex triode assembly, wherein the electrons oscillate back-and-forth between the subsequently formed virtual cathode at the B-cusp region (within a field generated by the B-insulation magnets 140e) near the output of the physical tapered anode 140a and the physical cathode 140b, generating a high current density gas-plasma ion source while also providing the accelerating E-field gradient for efficient ion beam extraction.

The pulsed power modules IRMGs 110 are each operably connected to a respective reflex triode assembly to drive that reflex triode assembly. Within exemplary embodiments of the present invention at least two DPF Marx modules 105 are operably connected to the dual DPF assemblies 130a, 130b to drive the dual DPF assemblies 130a, 130b so that in operation the IRMG 110 and DPF Marx modules 105 work together to power the WARP core 120. As shown in FIG. 3, the IRMGs 110 are each connected to opposing ends of the WARP core 120 to a respective DPF assembly 130a, 130b.

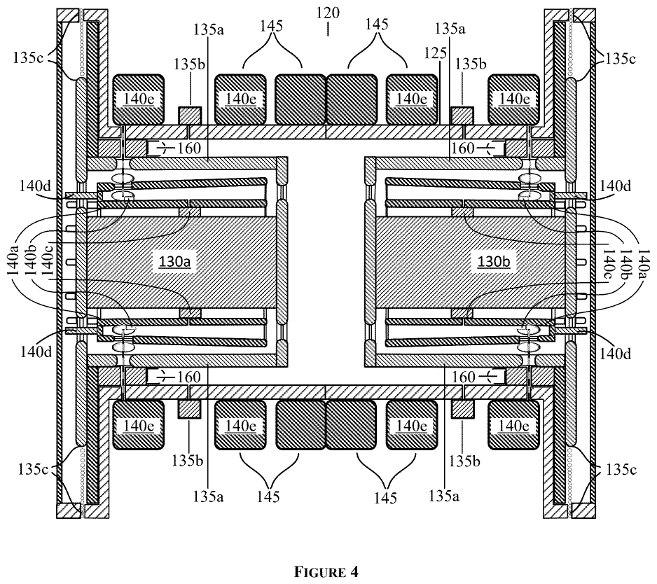

FIGS. 4-11 show a detailed cross-sectional view of an exemplary embodiment of the WARP core 120 and the coaxial face-to-face arrangement of two DPF assemblies 130a, 130b wherein a reflex triode assembly is embedded in each of the DPF assemblies 130a, 130b. As illustrated, the two DPF assemblies 130a, 130b are positioned and arranged so that generated ion rings are fired at each other from the opposing DPF/reflex triode assembly 130a, 130b. Also shown are the DPF anodes 135a, as well as the annular DPF gas puff valves 135b that are situated adjacent to the B-insulation 140e and B-Seed/B-cusp 145 pulsed coil magnets which are arranged around the grounded vacuum chamber 125.

Further illustrated in FIGS. 4-11 are two IRMG gas puff valves 140c shown positioned between the IRMG anodes 140a and IRMG cathodes 140b of the reflex triode assemblies and the DPF center electrodes. The DPF Marx modules 105 attach to the WARP core 120 at the DPF collection plates 135c on the left and right ends of the WARP core 120 and drive the dual DPF assemblies 130a, 130b. The IRMGs 110 are each operably connected to the back-ends of each reflex triode assembly through IRMG Post-hole convolutes 140d.

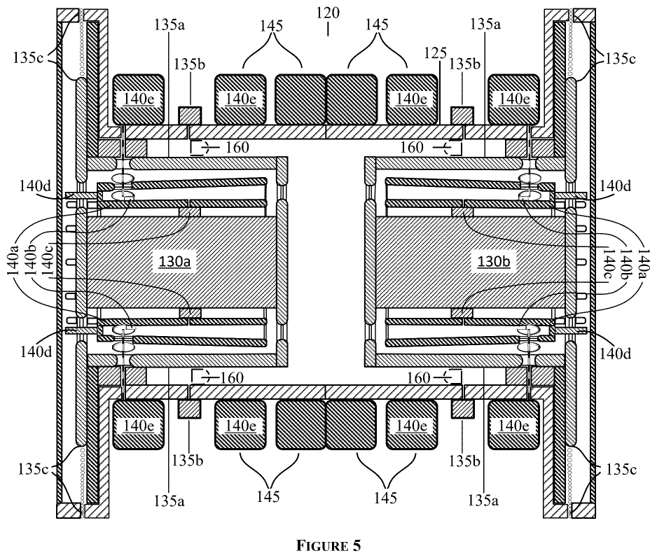

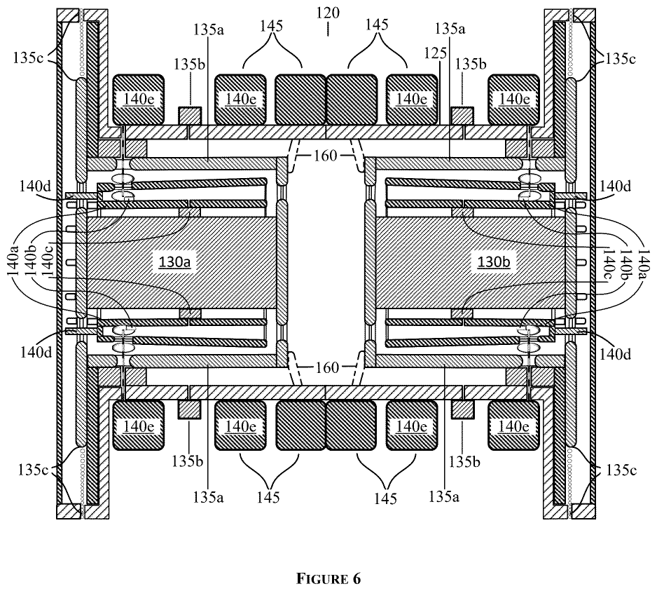

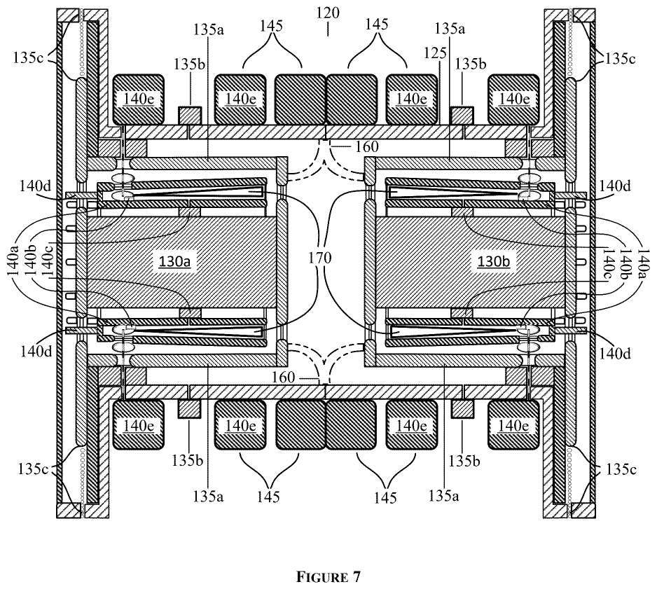

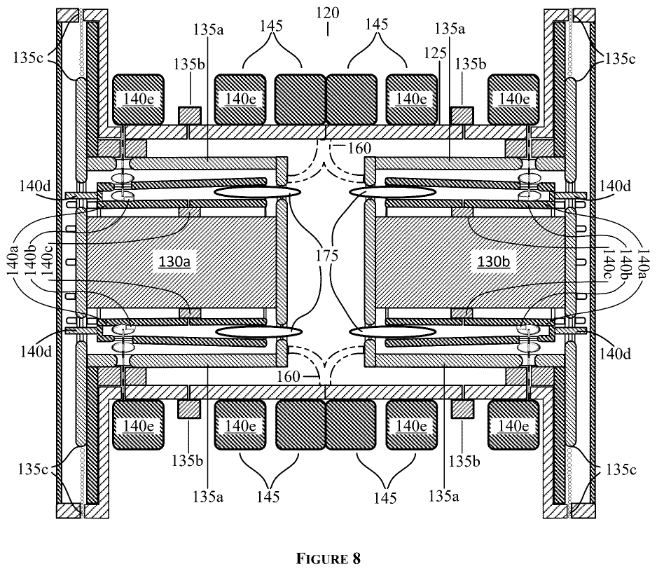

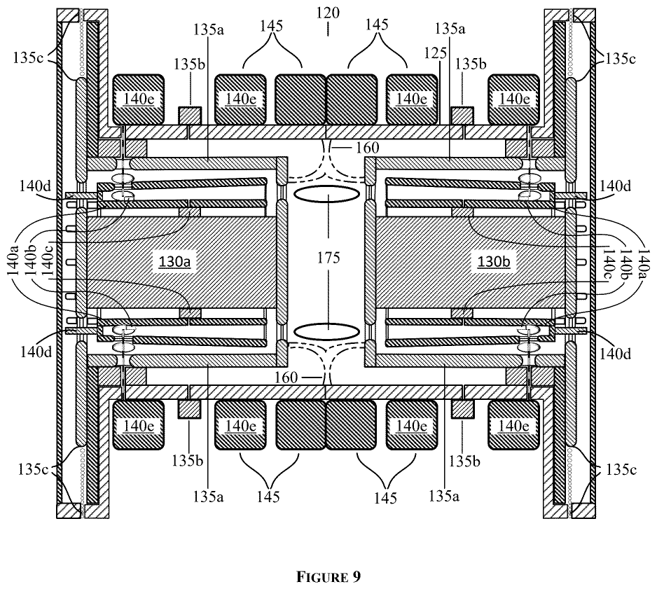

The key operational phases of the WARP reactor 100, including: the plasmoid lift-off phase (FIG. 4), the run-down phase (FIG. 5), the end of run-down phase (FIG. 6), the run-in phase (FIGS. 7 and 8), and the imploding plasma liner phase (FIG. 9) are illustrated in FIGS. 4-11.

FIG. 4 shows the plasma lift-off phase occurring at the DPF assemblies 130a, 130b. This is the phase wherein the initial plasmoid 160 is formed and accelerated by the DPF assemblies 130a, 130b within the WARP reactor system 100. In a ring pinch configuration, the plasmoid 160 is confined and accelerated via magnetic fields produced by the B-insulation magnets 140e, this phase representing the moment when energy input initiates the plasmoid's 160 movement. In this phase electromagnetic waves or pulses are used to impart momentum, leading to the plasmoid 160 achieving self-sustaining stability.

FIG. 5 shows the run-down phase of the DPF assemblies 130a, 130b, wherein the plasmoid 160 is accelerated toward the mid-plane of the WARP core 120. Within the rundown phase magnetic containment of the plasmoid 160 is reduced and the plasmoid 160 gradually loses energy, this controlled dissipation of energy being required to prevent the instability or unwanted dispersion of the plasmoid 160. FIG. 6 illustrates the end of the run-down phase of the DPF assemblies 130a, 130b.

FIG. 7 shows the start of the DPF assemblies' 130a, 130b run-in phase, wherein annular ion beams 170 are generated. This step illustrates the initial conditioning of the plasmoid 160 before full acceleration, where operational parameters like magnetic field stability, density, and temperature are optimized by the WARP reactor system 100, this phase helping to achieve the conditions necessary for plasma confinement and ignition. FIG. 8 shows the run-in phase of the DPF assemblies 130a, 130b where the generated ion beams 170 are compressed into ion rings 175.

FIG. 9 shows the imploding plasmoid 160 liner phase of the DPF assemblies 130a, 130b where the opposing generated ion rings 175 are merged. The imploding phase refers to the intentional collapse of the plasmoid liner 160 due to the excessive inward magnetic pressure provided by the DPF plasmoid self-currents and the B-seed/B cusp 145 magnetic coils.

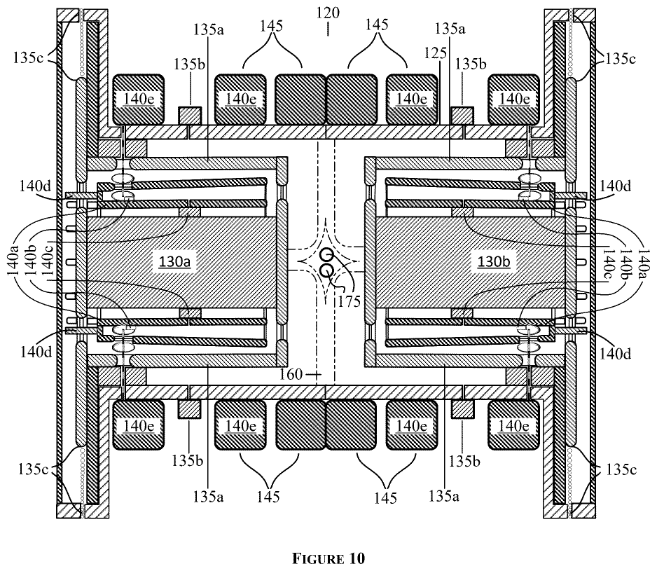

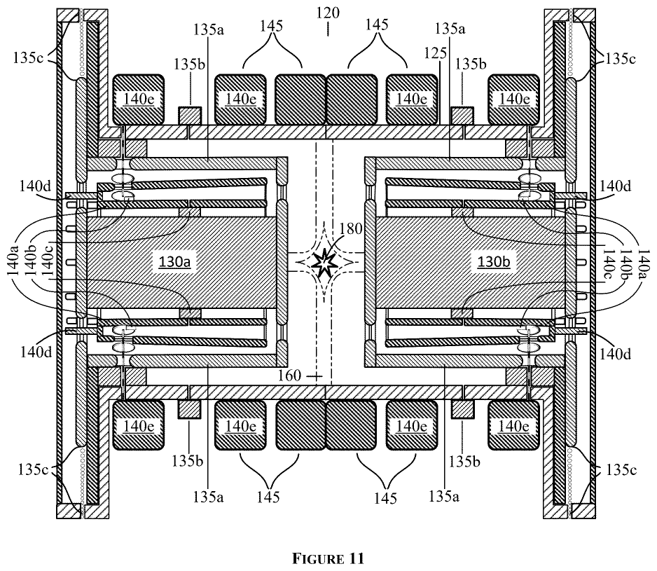

FIG. 10 illustrates the radial pinching and azimuthal acceleration of the plasmoid 160 pinch and an ion ring 175 compression phase of the DPF assemblies 130a, 130b. And finally, FIG. 11 shows the end phase 180 of the DPF assemblies 130a, 130b which by analyzing the results of a particular experiment will enable the study of relativistic high energy density physics, magneto-inertial fusion, and super-radiant flash x-ray/neutron generation.

An exemplary embodiment of the invention comprises a compact, modular, and scalable pulsed power-driven radiation source system 100. The system 100 comprises the following: at least two DPF Marx modules 105, at least two IRMG 110, and a WARP core 120.

The WARP core 120 comprises at least two DPF assemblies 130a, 130b, the DPF assemblies 130a, 130b being configured to receive pulsed power from the at least two DPF Marx modules 105. Within embodiments of the present invention pairs of DPF assemblies 130a, 130b are coaxially aligned and physically arranged so that a first DPF assembly 130a and a second DPF assembly 130b are oriented to face each other, thus enabling each facing DPF assembly 130a, 130b to have the capability to generate and accelerate plasmoids 160 towards the opposing DPF assembly 130a, 130b along the same axis with subsequent merging of the plasmoids 160 and plasmoid liner compression.

Each DPF assembly 130a, 130b further comprises a reflex triode assembly for the generation and acceleration of charged particle rings 175. The reflex triode assembly comprise components that consist of IRMG anodes 140a, IRMG cathodes 140b, IRMG gas puff valves 140c, and reflex triode B-insulation pulse coil magnets 140e. Each reflex triode assembly is configured to receive pulsed power from a corresponding IRMG 110.

A B-cusp/B-seed magnetic flux compression system 145 is integrated with the WARP core 120 to provide radial compression and azimuthal acceleration of merged charged particle rings 175 to increase the energy of the merged charged particle rings 175.

The at least two DPF Marx modules 105, the at least two IRMGs 110, and the WARP core 120 are operatively coupled to achieve a compact, scalable, modular system for generating relativistic high-energy density charged particle beams and facilitating nuclear fusion, advanced propulsion, and radiographic applications. Within further embodiments of the present invention the B-cusp/B-seed magnetic flux compression system 145 is configured to provide an axial magnetic flux compression phase that increases charged particle ring 175 energies by up to 10³ times the initial charged particle ring 175 energy.

Comprised within exemplary embodiments of the present invention is a control system (not shown) that is configured to synchronize the operation of the DPF Marx modules 105, the DPF assemblies 130a, 130b, and the IRMGs 110 to enhance the timing and energy efficiency of plasmoid 160 and charged particle ring 175 formation and compression. Additionally, the WARP core 120 of the present invention can be configured to generate multi-pulse electromagnetic pulses (EMPs) and intense gamma, x-ray, neutron, and charged-particle fluxes for assessing radiation environments.

In yet further exemplary embodiments of the present invention the pulsed power-driven radiation source system 100 comprise at least two and up to forty DPF Marx modules 105. Each IRMG 110 of the present invention can produce a IMV, IMA, 100 ns pulse. The pulsed power-driven radiation source system 100 can achieve a DPF/Z-Pinch current of 60 MA and a final ion beam/ring energy of 1 GeV. In addition, the pulsed power-driven radiation source system 100 can be configured to achieve a scientific gain of greater than 19 and a fusion triple product of at least 5×10\hat{ }21 keV s/m\hat{ }3.

An additional exemplary embodiment of the present invention comprises a method for generating high-energy density charged particle beams. The method comprises the steps of providing a compact modular and scalable pulsed power-driven radiation source system 100. The system 100 comprising at least two DPF Marx modules 105, at least two IRMGs 110, and a WARP core 120. The WARP core 120 comprises at least two DPF assemblies 130a, 130b and is integrated with B-insulation pulse coil magnets 140e and B-cusp/B-seed magnetic flux compression systems 145, each DPF assembly 130a, 130b further comprising a reflex triode assembly.

The method further comprises the steps of configuring pairs of DPF assemblies 130a, 130b within the WARP core 120 to be coaxially aligned and oriented to face each other, delivering pulsed power from the DPF Marx modules 105 to the DPF assemblies 130a, 130b, delivering pulsed power from a respective IRMG 110 to a corresponding reflex triode assembly and discharging plasmoids 160 and charged particle rings 175 from each DPF assembly 130a, 130b towards the opposing DPF assembly 130a, 130b along a common axis.

Plasmoids 160 and charged particle rings 175 are merged at a common focal point within the WARP core 120, compressing the merged plasmoids 160 and charged particle rings 175 into a plasma liner using the B-cusp/B-seed magnetic flux compression system 145 that is integrated with the WARP core 120 to increase the energy of the plasmoids 160 and charged particle rings 175. The result is the capability to utilize the generated relativistic high-energy density charged particle beams for research applications in fields such as nuclear fusion, advanced propulsion, and radiographic assessments.

Within further exemplary embodiments of the present invention the step of compressing the merged plasmoids 160 into a plasmoid liner further comprises the step of initiating an axial magnetic flux compression phase within the WARP core 120. Thereafter, the charged particle rings 175 are radially compressed and azimuthally accelerated to achieve charge particle ring 175 energies increased by up to 10³ times their initial energy.

The step of synchronizing the discharge of plasmoids 160 and charge particle rings 175 from the DPF assemblies 130a, 130b and the operation of the IRMGs 110 are initiated and executed through a WARP reactor 100 control system (not shown). Via the WARP reactor 100 control system the timing of the discharges can be adjusted to optimize energy efficiency and enhance the formation and compression of the plasmoids 160 and charged particle rings 175.

Within yet further exemplary embodiments of the present invention multi-pulse EMPs, intense gamma rays, X-rays, neutron fluxes, and charged-particle fluxes are generated by use of the WARP core 120. Additionally, radiation environments can be assessed by directing the generated fluxes onto a target. Within exemplary embodiments of the present invention final ion ring 175 currents of 20 MA and an acceleration efficiency of 25% can be achieved.

The WARP reactor 100 represents a groundbreaking advancement in pulsed power-driven radiation technology. Its ability to generate high-energy radiation in a compact, efficient, and cost-effective manner positions it as a transformative tool across multiple domains. Potential future developments include enhanced fusion energy systems, advanced propulsion mechanisms for interstellar exploration, and deeper explorations into the fundamental principles of high-energy physics.

The WARP reactor 100 allows access to new relativistic high energy density physics regimes for probing the intersection between General Relativity and Quantum Field Theory, and the methods of use will allow access to spacetime metric engineering via the Anderson Unruh/Casimir Effect.

While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the embodiments disclosed for carrying out this invention, but that the invention will include all embodiments falling within the scope of the claims.

What is claimed:

1. A compact, modular, and scalable pulsed power-driven radiation source system, the system comprising:
at least two dense plasma focus (DPF) Marx modules;
at least two ion ring Marx generators (IRMG); and
a WARP core, the WARP core comprising:
at least two DPF assemblies, the DPF assemblies being configured to receive pulsed power from the at least two DPF Marx modules,
pairs of DPF assemblies are coaxially aligned and physically arranged so that a first DPF assembly and a second DPF assembly are oriented to face each other, thus enabling each facing DPF assembly to have the capability to generate and accelerate plasmoids towards the opposing DPF assembly along the same axis with subsequent merging of the plasmoids and plasmoid liner compression; and
each DPF assembly further comprising a reflex triode assembly for the generation and acceleration of charged particle rings, each reflex triode assembly being configured to receive pulsed power from a corresponding IRMG; and
a magnetic flux compression system integrated with the WARP core to provide radial compression and azimuthal acceleration of merged charged particle rings to increase the energy of the merged charged particle rings;
wherein the at least two DPF Marx modules, the at least two IRMGs, and the WARP core are operatively coupled to achieve a compact, scalable, modular system for generating relativistic high-energy density charged particle beams and facilitating nuclear fusion, advanced propulsion, and radiographic applications.

2. The system of claim 1, wherein the plasmoids and charged particle rings that are discharged from a first and second DPF assembly travel towards each other along predetermined trajectories towards a common focal point, when the plasmoids and charged particle rings converge, they are merged into a single coherent plasmoid and charged particle ring structure.

3. The system of claim 2, wherein the magnetic flux compression system is configured to provide an axial magnetic flux compression phase that increases charged particle ring energies by up to 1000 times the initial charged particle ring energy.

4. The system of claim 3, further comprising a control system that is configured to synchronize the operation of the DPF Marx modules, the DPF assemblies, and the IRMGs to enhance the timing and energy efficiency of the plasmoid and charged particle ring formation and compression.

5. The system of claim 4, wherein the WARP core is configured to generate multi-pulse electromagnetic pulses (EMPs) and intense gamma, x-ray, neutron, and charged-particle fluxes for assessing radiation environments.

6. The system of claim 5, wherein the pulsed power-driven radiation source system comprises at least two and up to forty DPF Marx modules.

7. The system of claim 5, wherein each IRMG can produce a 1 MV, IMA, 100 ns pulse.

8. The system of claim 5, wherein the pulsed power-driven radiation source system can achieve a DPF/Z-Pinch current of 60 MA and a final ion beam/ring energy of 1 GeV.

9. The system of claim 5, wherein the pulsed power-driven radiation source system is configured to achieve a scientific gain of greater than 19 and a fusion triple product of at least 5×10\hat{ }21 keV s/m\hat{ }3.

10. A method for generating high-energy density charged particle beams, comprising the steps of:
providing a compact modular and scalable pulsed power-driven radiation source system comprising:
at least two Dense Plasma Focus (DPF) Marx modules,
at least two Ion Ring Marx Generators (IRMGs), and
a WARP core, the WARP core comprising at least two DPF assemblies and is integrated with a magnetic flux compression system, each DPF assembly further comprising a reflex triode assembly;
configuring pairs of DPF assemblies within the WARP core to be coaxially aligned and oriented to face each other;
delivering pulsed power from the DPF Marx modules to the DPF assemblies;
delivering pulsed power from a respective IRMG to a corresponding reflex triode assembly;
discharging plasmoids and charged particle rings from each DPF assembly towards the opposing DPF assembly along a common axis;
merging the plasmoids and charged particle rings at a common focal point within the WARP core;
compressing the merged plasmoids and charged particle rings into a plasma liner using a magnetic flux compression system integrated with the WARP core to increase the energy of the plasmoids and charged particle rings;
utilizing the generated relativistic high-energy density charged particle beams for applications such as nuclear fusion, advanced propulsion, and radiographic assessments.

11. The method of claim 10, wherein compressing the merged plasmoids into a plasmoid liner further comprises the step of initiating an axial magnetic flux compression phase within the WARP core.

12. The method of claim 11 further comprising the step of radially compressing the charged particle rings and azimuthally accelerating them to achieve charge particle ring energies increased by up to 1000 times the initial energy.

13. The method of claim 10, further comprising the step of synchronizing the discharge of plasmoids and charge particle rings from the DPF assemblies and the operation of the IRMGs through a control system.

14. The method of claim 13, further comprising the step of adjusting the timing of the discharges to optimize energy efficiency and enhance the formation and compression of the plasmoids and charged particle rings.

15. The method of claim 10, further comprising the step of generating multi-pulse electromagnetic pulses (EMPs), intense gamma rays, X-rays, neutron fluxes, and charged-particle fluxes using the WARP core.

16. The method of claim 15, further comprising the step of assessing radiation environments by directing the generated fluxes onto a target.

17. The method of claim 10, wherein the method achieves a final ion ring current of 20 MA and an acceleration efficiency of 25%.

18. The method of claim 10, wherein the method allows access to new relativistic high energy density physics regimes for probing the intersection between General Relativity and Quantum Field Theory.

19. The method of claim 10, wherein method allows access to spacetime metric engineering via Anderson Unruh/Casimir Effect.
